(19) United States
(12) Patent Application Publication
(10) Pub. No.: US 2007/0064224 A1
(43) Pub. Date: Mar. 22, 2007

(54) Method and device for inspecting a wafer

(76) Inventors: Albert Kreh, Solms (DE); Henning Backhauss, Wetzlar (DE)

Correspondence Address: SIMPSON & SIMPSON, PLLC, 5555 MAIN STREET, WILLIAMSVILLE, NY, 14221-5406, US

(21) Appl. No.: 10/571,207

(22) PCT Filed: Aug. 27, 2004
(86) PCT No.: PCT/EP04/51946

§ 371 Date: Oct. 13, 2006

(30) Foreign Application Priority Data
Sep. 18, 2003 (DE) 103 43 148.9

(51) Int. Cl. G01N 21/88

(52) U.S. Cl. 356/237.2

(57) ABSTRACT

The present invention relates to a method and a device for the inspection of a wafer. The method comprises the following steps: illuminating at least one section of a surface of the wafer; acquiring an image of the illuminated section of the surface of the wafer using an image acquisition unit; determining at least one image area in the acquired image; and changing a size of an image field of the image acquisition unit on the basis of the at least one image area. To determine the image area, pattern recognition software searches for prominent structures in the acquired image. By changing the image field size, the throughput or the resolution of a wafer inspection device may be optimized alternately and the image field may always be tailored optimally to the shot size of the wafer.

The present invention relates to a method and a device for the inspection of a wafer and particularly relates to a method and a device for the detection of macrodefects using optimizable detection parameters.

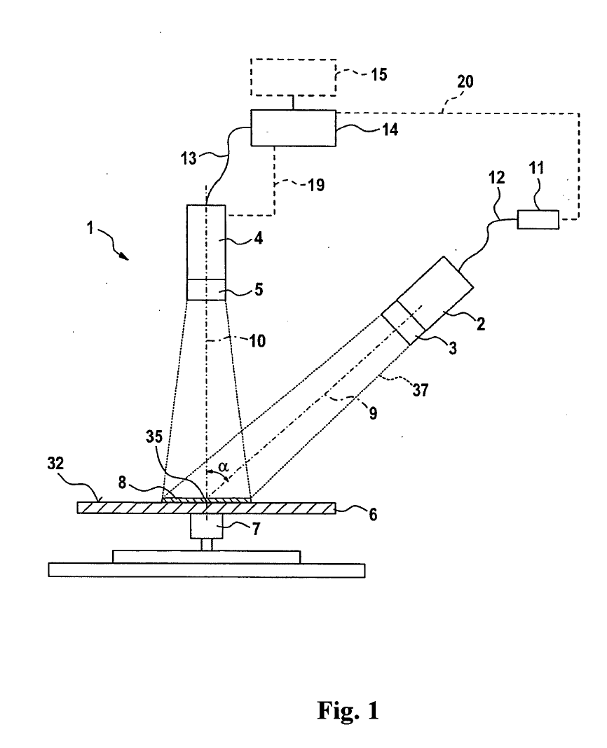

FIG. 1 shows the basic construction of a wafer inspection device for the inspection of wafers in a dark field arrangement. The wafer inspection device 1 comprises a direct light illumination unit 2 having an objective 3 in order to irradiate the illumination light beam 37 along the axis of illumination 9 on the surface 32 of the wafer 6 at an angle α. The illumination light is frequently coupled into the direct light illumination unit 2 from a separate light source 11, such as a xenon lamp or a xenon flashlamp, via an optical fiber bundle 12. An area 35 is illuminated on the surface 32 of the wafer 6.

The wafer inspection device 1 also comprises an image acquisition unit 4, such as a matrix or line camera, in particular a CCD camera, having an objective 5. The image acquisition unit 4 is oriented along the imaging axis 10, which intersects the surface 32 of the wafer 6 perpendicularly in the example shown. The objective 5 predefines an image field 8, which is acquired by the image acquisition unit 4. In the example shown, the image field 8 overlaps essentially completely with the illuminated area 35, but it may also be smaller, of course. Image data of an image acquired by the image acquisition unit 4 of the surface 32 of the wafer 6 is input by the data readout unit 14 via the data line 13 and shown on the monitor 15 or a comparable display or analyzed further to identify defects after appropriate processing.

The wafer 6 is held by a wafer receiving unit 7. A flat or notch (not shown) of the wafer 6 is used for orientation of the wafer 6, so that the wafer 6 is held in the wafer inspection device 1 in a known and predefinable orientation. The wafer inspection device 1 may be part of a wafer processing device or may be positioned downstream therefrom, for which purpose the wafer 6 may be transferred to the wafer inspection device 1 oriented after processing.

The wafer inspection devices known from the related art share the feature that their image acquisition unit, such as their matrix or line camera, is always operated using a fixed image field. This results in a fixed resolution of the known wafer inspection devices, which may not be changed during running operation. In order to nonetheless obtain a suitable pixel resolution, cameras having a high pixel count are typically used, which makes the image acquisition and image processing complex. In addition, the typical image acquisition using a fixed image field is not always optimally tailored to the conditions of a current wafer processing. A typical wafer inspection device having a constant image field may always be operated only at a constant throughput, measured in chips and/or wafers inspected per time unit, for example, because the throughput is essentially predefined by the maximum repetition frequency of flashlamps used as the light source, by the maximum speed at which the wafer may be guided through the wafer inspection device, etc.

The object of the present invention is to provide a method and a device for the inspection of wafers, so that a wafer inspection may be performed more variably and flexibly. Furthermore, a method and a device for the inspection of wafers are to be provided, using which an optimum resolution or an optimum throughput may always be achieved.

This object is achieved by a method having the features according to claim 1 and by a device having the features according to claim 12. Further advantageous embodiments are the subject matter of the subordinate claims.

In a method for the inspection of a wafer according to the present invention, a surface of the wafer is at least partially illuminated, an image of an illuminated section of the surface of the wafer is acquired, at least one image area in the acquired image is determined, and a size of an image field of the image acquisition unit is changed on the basis of the at least one image area.

Therefore, according to the present invention, the size of the image field of the image acquisition unit may be tailored optimally to the conditions of a wafer processing. In particular, in the method according to the present invention, an optimum resolution, an optimum throughput of the wafer inspection device, an optimum image size, etc., may be achieved. Overall, a wafer inspection device may thus be operated more variably and flexibly.

The size of the image field of the image acquisition unit may preferably be changed at any time, for example to adapt to a changed chip size in a new batch to be processed or to change the resolution of the wafer inspection device during a running processing. The present invention is thus based on an abandonment of the typical principle, according to which the image acquisition unit in a wafer inspection device always operates using a fixed image field. Through the surprisingly simple achievement of the object of being able to change the image field of the image acquisition unit at any time, a wafer may be examined more variably and efficiently for defects according to the present invention.

According to the present invention, the wafer inspection device may be operated in a dark field arrangement, in a bright field arrangement, or using both simultaneously. Preferably, the wafer inspection device may be switched over between these two types of operation, for example, through selective activation of a bright field and/or dark field direct light illumination unit. After acquisition of a sample image of the illuminated section of the surface of the wafer, according to the present invention, at least one image area is determined, to which the size of the image field is to be tailored in a following step. The determination of the image area may be performed manually, for example, by an operator on the basis of a display screen, or automatically using suitable pattern recognition software, which recognizes prominent structures on the surface of the wafer. The determined image area may be a die, a wafer area comprising multiple dies, a chip to be manufactured or a subarea thereof, or a stepper shot of a wafer stepper. If it is established according to the present invention that an image field size used currently is not tailored optimally to the size of the image area determined, the size of the image field is changed.

To change the size of the image field, the focal width of an objective may be changed, which may also be implemented by pivoting an objective having another focal width, such as an objective of a revolver objective holder, into the imaging beam path. To change the size of the image field, a distance between the image acquisition unit, such as a CCD camera, and the surface of the wafer may be changeable, in which case an objective of the image acquisition unit must be refocused after changing the image distance, or an objective may be changed, using a revolver holder, for example. A zoom objective, which may be adjusted manually or electronically, is very especially preferably connected upstream from the image acquisition unit, the surface of the wafer always being imaged sharply in the image acquisition unit.

The size of the image field is preferably changed in such a way that a variable derived from the at least one determined image area assumes a predetermined value or the derived variable is optimized. An objective measure is provided by the variable derived from the at least one determined image area, in order to judge whether the size of the current image field is tailored optimally to the current conditions of the wafer processing. This variable may be used both in case of manual change of the image field size and also in case of electronically controlled or regulated change of the image field size. The variable is preferably derived from distances or pixel counts derived in a sample recording of the surface of the wafer.

The predetermined value preferably corresponds to a distance of the at least one determined image area to the edges of the acquired image field and/or to a pixel resolution of the image acquisition unit and/or to a number of dies per acquired image field and/or to a number of dies in the longitudinal and/or transverse directions of the acquired image field and/or to a throughput of the wafer inspection device per time unit. All of these variables may be determined completely automatically, with the aid of pattern recognition software, for example, in the line or matrix image acquired by the image acquisition unit, so that the image field size may also be changed in a way, which is controlled or regulated automatically.

According to a further embodiment, the image field size may be changed iteratively, i.e., in a first step, the image field size is changed in one direction, i.e., enlarged or reduced, and the image area is determined again from an image acquired at the changed image field size, and the above-mentioned variable is derived therefrom and compared to the variable at the prior image field size. It may be derived from the comparison whether the image field size was changed in the correct direction, i.e., enlarged or reduced. The steps are performed until the derived variable assumes the predetermined value, possibly taking minimum tolerances into consideration, or the derived variable is optimized in accordance with an optimization algorithm.

For automatic change of the image field size, pattern recognition, which determines prominent structures on the surface of the wafer according to a predetermined scheme, such as edges and/or corner areas and/or predetermined structures and/or marks on the surface of the wafer, may be performed to determine the at least one image area. Further variables may then be derived electronically knowing the position of these prominent structures, such as distances or pixel counts in a current acquired image.

Of course, the prominent structures may also be taught, for example, by manual or semiautomatic input of these structures into software for controlling the method and/or the device.

A pixel resolution of the image acquired by the image acquisition unit is very especially preferably determined automatically using the method according to the present invention, the image field being changed in such a way that a predefined minimum pixel resolution is ensured, so that macrodefects on the surface of the wafer may be identified reliably.

According to a further aspect, the present invention also relates to a device for the inspection of a wafer, which is designed to execute the method described herein.

In the following, the present invention is described for exemplary purposes with reference to the attached drawing, from which further features, advantages, and objects to be achieved result and in which:

FIG. 1 shows a schematic side view of a wafer inspection device as it may be used according to the present invention;

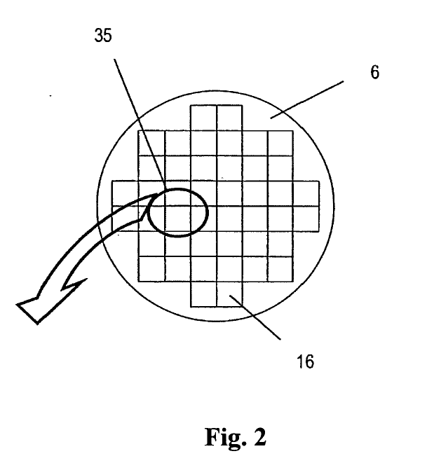

FIG. 2 shows a schematic top view of a wafer to be examined;

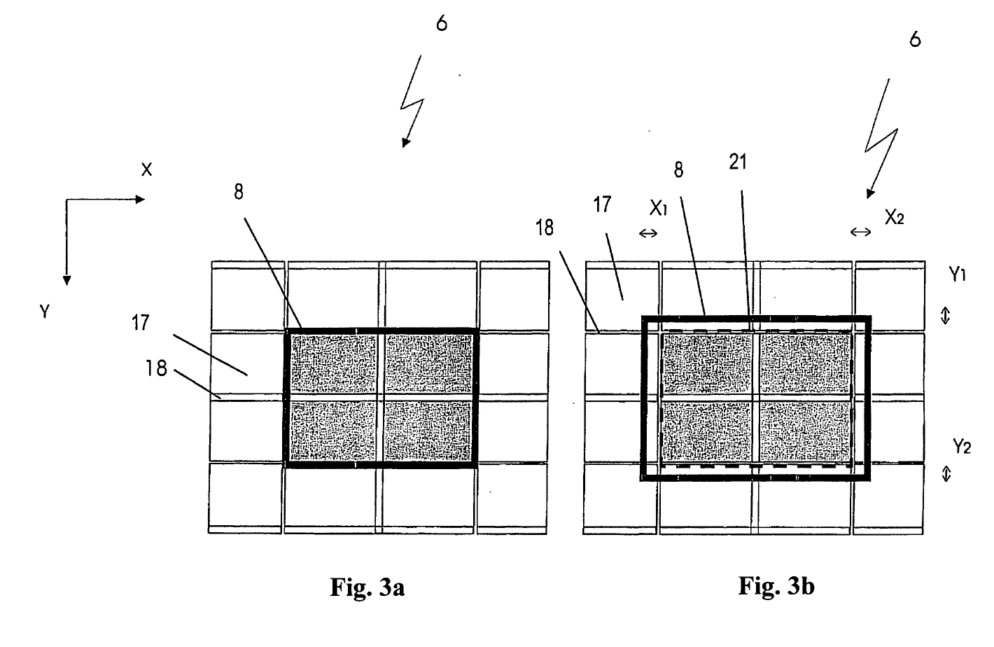

FIGS. 3a and 3b show an acquired image field before and after an image field optimization for contrast;

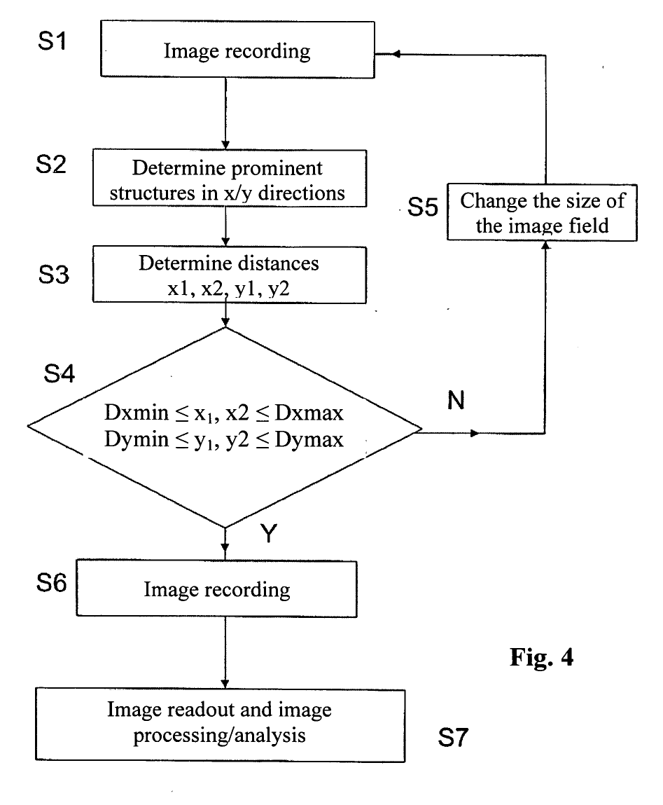

FIG. 4 shows a schematic flowchart for image field optimization according to FIG. 3;

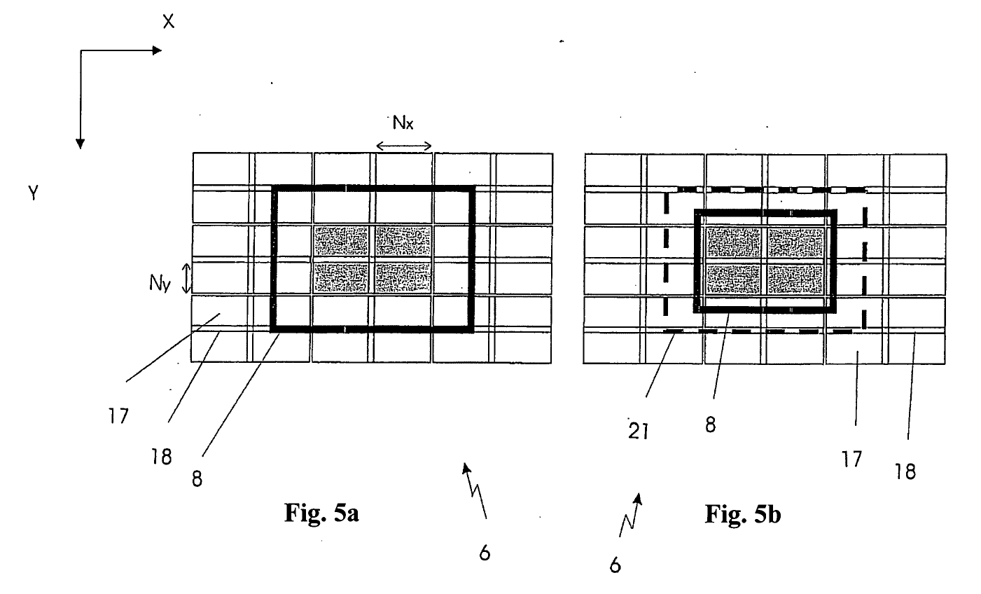

FIGS. 5a and 5b show an acquired image field before and after optimization of the resolution of the acquired image;

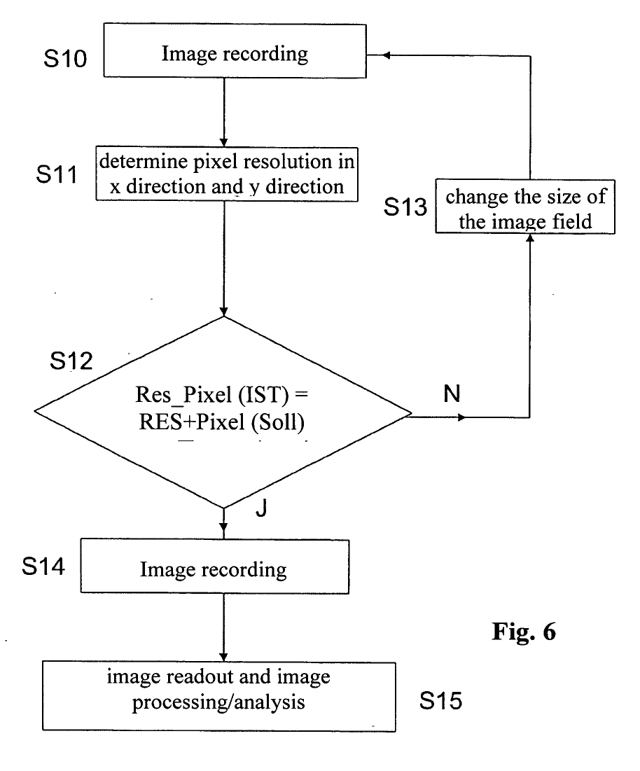

FIG. 6 shows a schematic flowchart of steps for optimizing the resolution of the acquired image field according to FIGS. 5a and 5b;

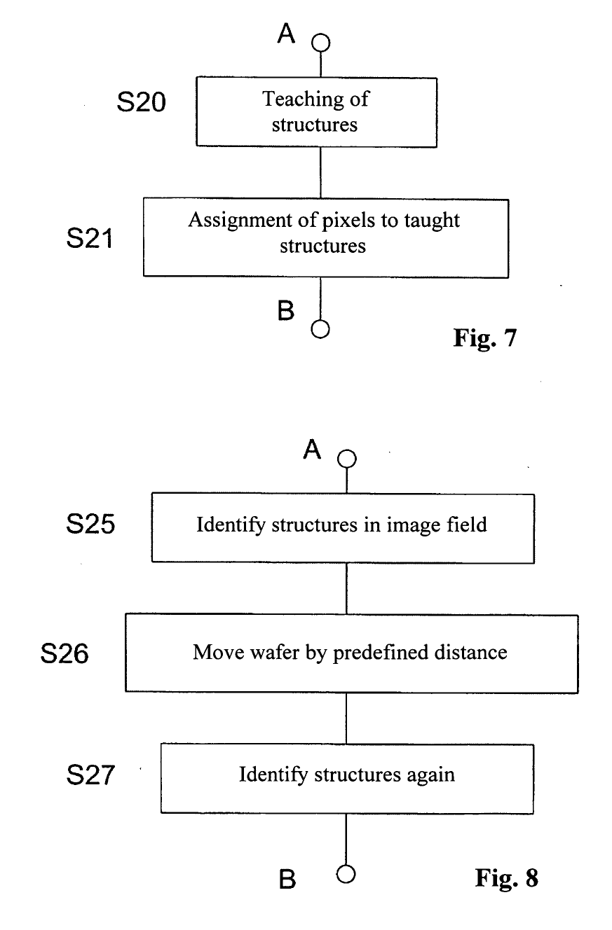

FIG. 7 shows a partial step in the method according to FIG. 6; and

FIG. 8 shows another partial step in the method according to FIG. 6.

In the figures, identical reference numbers identify identical or essentially identically acting elements or element groups.

As shown in FIG. 1, in a wafer inspection device 1 according to the present invention, the following additional precautions are taken in comparison to the related art described above: the image acquisition unit 4, such as a line or matrix camera, especially preferably a CCD camera, comprises a zoom objective 5, whose focal width may be changed manually or electronically, the surface 32 of the wafer 6 always being imaged sharply in the image acquisition unit 4. Alternatively or additionally, the distance between the image acquisition unit 4 and the surface 32 of the wafer 6 may be changed, for example, by displacing the image acquisition unit 4 along the imaging axis 10 manually or using an electric motor. After a change of the image distance, the objective 5 must be refocused. Alternatively or additionally, the distance between the objective 5 and the image acquisition unit 4, in particular a CCD chip (not shown), may be changed after a change of the image distance in order to image the surface 32 of the wafer 6 in the image acquisition unit 4 sharply again. The objective 5 may also be held by a pivotably mounted revolver objective holder, which accommodates multiple objectives having different focal widths, so that the focal width may also be changed rapidly by pivoting an objective of a suitable different focal width into the imaging beam path. To control the above-mentioned steps, a data line 19 may be provided between the image acquisition unit 4 and the data readout unit 14, such as a computer. In case of manual adjustment of the image acquisition unit 4, the computer may also generate a note for an operator on the display 15 as to whether the adjustment is already sufficient for an image field optimization, as described in the following, or whether a further adjustment is required for an image field optimization.

According to FIG. 1, the wafer inspection device 1 is shown in a dark field arrangement, in which the illumination light beam 37 is not reflected back directly into the image acquisition unit 4 from the surface 32 of the wafer 6. Of course, the wafer inspection device 1 may also be operated in a bright field arrangement, in which the illumination light is reflected directly into the image acquisition unit 4. A further direct light illumination unit (not shown) may be provided for a bright field arrangement and the particular direct light illumination unit may be selected by turning it on alternately, for which purpose the illumination units 11 are connected via a data line 20 to the data readout unit 14 used as a control unit. Alternatively or additionally, the angle of incidence a of the direct light illumination unit 2 may also be changed to adapt to the particular illumination geometry used.

FIG. 2 shows a schematic top view of a wafer to be inspected. The wafer 6 is divided into multiple essentially rectangular subareas 16, which correspond to stepper shots of a wafer stepper in the example shown. The individual stepper shots 16 may comprise one or more dies. As shown in FIG. 2, an essentially planar area 35 is illuminated by the direct light illumination unit, which, as indicated by the arrow, is to be shown enlarged in FIGS. 3 and 5, described in the following. The planar area 35 may have the shape of a circle or a rectangle.

FIGS. 3a and 3b show a procedure for optimizing the image field according to the present invention. The case of a CCD camera used as the image acquisition unit having an essentially rectangular CCD chip is assumed. At a selected imaging scale, an image field 8 having a size corresponding to FIG. 3a is assigned to the essentially rectangular CCD chip. As shown in FIG. 3a, multiple essentially rectangular dies 17 are implemented on the surface of the wafer 6, which are separated from one another by partition areas 18, which run essentially perpendicular to one another and along which the wafer 6 is sawed apart after the processing.

The thick black line, which encloses the image field 8, is no longer imaged on the CCD chip of the image acquisition unit. As may be inferred from FIG. 3a, no single one of the four gray shaded dies 17 which are in the image field 8 is thus imaged completely on the CCD chip in the example shown. However, defects may exist precisely in these die areas not imaged on the CCD chip. In order to detect such defects reliably, according to the related art, the wafer 6 must be shifted in relation to the image acquisition unit in such a way that in a second image recording, the areas of a die 17 not previously imaged on the CCD chip, i.e., the areas below the thick black line in FIG. 3a, are imaged on the CCD chip. This requires at least four further image recordings, which reduces the throughput of the wafer inspection device and makes the image analysis complex, because at least four further image recordings must be analyzed before a reliable statement may be made about whether a die 17 has defects or not.

According to the present invention, the image field 8 of the image acquisition unit may be changed at any time, i.e., for example, even during a running processing. This is shown in FIG. 3b, in which the image field 8 was enlarged in comparison to FIG. 3a, for example, by changing the zoom factor or the imaging scale of the image acquisition unit 4. The dashed line indicates the image field 21 without image field optimization for comparison. As shown in FIG. 3b, the distance between the left edge of the image field 8 and the left edge of a die 17 still contained completely in the image field 8 is x1, the distance between the right edge of a die 17 still contained completely in the image field 8 and the right edge of the image field 8 is x2, the distance between the lower edge of the image field 8 and the lower edge of a die 17 still contained completely in the image field 8 is y2, and the distance between the upper edge of a die 17 still contained completely in the image area 8 and the upper edge of the image field 8 is y1.

Overall, the distances x1, x2, y1, and y2 are comparatively small in comparison to the dimensions of a die 17, so that nearly the entire image field area 8 may be used to detect defects and an optimum image field resolution may thus be achieved. By changing the size of the image field 8, defects on the entire surface of the dies 17 shaded gray in FIG. 3b i.e., a total of four dies, may be detected using one single image recording, without a further image recording being necessary. Therefore, the throughput of the wafer inspection device may be significantly increased in comparison to FIG. 3a, by a factor of approximately 4 in the example shown.

As is obvious to one skilled in the art without anything further, the size of the image field 8 may also be changed, of course, in such a way that only one single die 17 is completely within the image field 8. In this case, the achievable resolution would be even higher. For this purpose, the positioning of the wafer 6 in relation to the image acquisition unit, which is predefinable by a movable X/Y table or a stepping motor, must merely be changed suitably.

The partition areas 18 on the surface of the wafer 6 may be identified easily with the aid of pattern recognition software, so that the image field optimization described above may also be performed automatically instead of manually. The partition areas 18 represent only one example of prominent structures on the surface of the wafer 6 which may be recognized by pattern recognition software or an operator. Further examples are edges of individual dies 17, their corner areas, further prominent structures on the surface 32 of the wafer 6, or marks on the surface of the wafer 6. Such prominent structures will periodically repeat on the surface of the wafer 6, as may be seen from FIGS. 3a and 3b. Image field optimization according to the present invention may be performed as soon as a single die 17 may be identified reliably on the basis of at least two prominent structures along the X direction and/or the Y direction.

Of course, the image field optimization described above is also suitable for the purpose of shifting some areas of individual dies 17 completely into the image field 8, for example, memory areas of an integrated circuit, which has just been processed.

FIG. 4 shows a schematic flowchart of a procedure for image field optimization according to FIGS. 3a and 3b. Firstly, in step S1, an image of the surface of the wafer 6 is recorded, for example, the area shaded gray in FIG. 3a, which is formed by four individual dies 17, but does not contain them completely. Subsequently, in step S2, prominent structures in the X direction and Y direction are determined, for example, the partition areas 18 shown in FIG. 3a or the corners of the individual die 17.

Subsequently, in step S3, the particular distance of the prominent structures to the edge of the image field 8 is determined. According to FIG. 3a, only one partition area 18 in the X direction and the Y direction is determined by the pattern recognition software or the operator. Therefore, the distance in the X direction between the partition area 18 extending in the Y direction and the left or right edge of the image field 8 essentially corresponds to the length of an individual die 17, and the distance in the Y direction between the partition area 18 extending in the X direction and the lower or upper edge of the image field 8 essentially corresponds to a width of an individual die 17.

In the following step S4, it is determined whether the distances x1, x2, y1, and y2 thus ascertained lie within a predetermined range between predefinable limiting values Dxmin and Dxmax or Dymin and Dymax.

The distances x1, x2, y1, and y2 described above and the limiting values Dxmin, Dxmax, Dymin, and Dymax are expediently specified in pixel counts of the CCD chip of the image acquisition unit 4 used for the image readout.

If it is determined in step S4 that the above-mentioned distances x1, x2, y1, and y2 do not lay within the predetermined limiting ranges, the size of the image field 8 is changed suitably in step S5. Subsequently, the sequence returns to step S1 of a sample image recording and the loop of steps S2 through S5 is executed again until the condition according to step S4 has been fulfilled. The loop of steps S1 through S5 may be executed iteratively. In step S5, the size of the image field 8 may be changed randomly in one direction (i.e., enlarged or reduced). In step S5, the size of the image field 8 may also be changed systematically in a direction derived from the analysis, i.e., systematically enlarged or reduced, on the basis of an accompanying analysis of the image field 8 and the distances x1, x2, y1, and y2 ascertained in step S3. For example, if the distances x1, x2, y1, and y2 determined in step S3 correspond to approximately half of the width of the image field 8, software may determine that the image field 8 is to be enlarged, so that upon the next sample image recording in step S1, a total of four dies 17 are in the image field 8. The extent to which the size of the image field 8 is changed in step S5 may also be derived from an accompanying analysis of the prior sample image recording.

If the conditions in step S4 have been fulfilled, an image of the surface 32 of the wafer 6 is finally acquired by the image acquisition unit 4 in step S6, the acquired image is read out by the data readout unit 14 and processed further and analyzed suitably there. In particular, macrodefects on the surface of the wafer are sought in the image area thus acquired with the aid of software known in principle to one skilled in the art. Dies 17 and/or sections on the surface of the wafer 6 found to be flawed may be discarded or reprocessed suitably in following processing steps, until a satisfactory quality is also ensured for this die and/or section.

As one skilled in the art will recognize without anything further, the above-mentioned distances x1, x2, y1, and y2 may be selected as relatively small in comparison to the overall width and/or length of the image field 8 in order to ensure that the gray shaded area in FIG. 3b is reliably inside the actually acquired image.

FIGS. 5a and 5b schematically show the case of optimization of the resolution of the image field area in comparison. The thick black line indicates the edge of the acquired image field 8, which is no longer imaged on the CCD chip of the image acquisition unit 4. In the example according to FIG. 5a, the width (in the Y direction) of the acquired image field 8 is slightly larger than the width of four dies 17. Therefore, according to FIG. 5a, only four dies 17 are imaged on the CCD chip. Defects may be sought reliably on the basis of a single image recording only for the four gray shaded dies 17 in FIG. 5a. For all other dies 17, at least two image recordings are required, which reduces the throughput of the wafer inspection device and makes the image analysis relatively complex overall. Also, in regard to the four gray shaded dies 17 in FIG. 5a, the resolution achievable according to FIG. 5a is comparatively low measured in number of pixels per length unit on the wafer 6, for example, because large areas of the acquired image field 8 may not be used for an image analysis.

According to FIG. 5a, Nx and Ny identify the number of pixels of the CCD chip, which are available for a single die 17 along the X direction or the Y direction, respectively, at the selected resolution. As shown in FIG. 5a, the CCD chip comprises approximately 3.5×Nx pixels in the X direction and the CCD chip comprises approximately 4×Ny pixels in the Y direction. Only approximately 2Nx×2Ny=4Nx×Ny pixels may be exploited for reliable detection of defects according to FIG. 5a.

FIG. 5b shows the size of the acquired image field 8 after an image field optimization according to the present invention for comparison. In FIG. 5b, the dashed line 21 identifies the size of the image field before the image field optimization. The image field 8 was reduced in comparison to FIG. 5a, so that the distance between the outer edge of the four dies 17 marked gray in FIG. 5b and edge of the acquired image field 8, measured in number of pixels, for example, is relatively slight. The distance between the gray shaded dies and edge of the actual acquired image field 8 may be set to a predefinable minimum distance in the way described in FIG. 4.

According to FIG. 5b, more pixels are available in the X direction and the Y direction for detection of defects than in FIG. 5a, so that the pixel resolution may be increased overall. In comparison to FIG. 5a, the resolution is increased by a factor of approximately 1.8 according to FIG. 5b.

FIG. 6 shows a schematic flowchart of a procedure for image field optimization according to FIGS. 5a and 5b. Firstly, in step S10, a sample image recording of the surface of the wafer 6 is recorded. Subsequently, prominent structures are identified in the sample image recording, for example, the partition areas 18 illustrated in FIG. 5a. It is thus ascertained in the sample image recording according to FIG. 5a that a total of four dies 17 as are predefined by the partition areas 18 are in the image field 8.

Subsequently, the pixel resolution actually achieved in the sample image recording is determined in step S11. For this purpose, the number of pixels Nx between two partition areas 18 along the X direction and/or Ny between two partition areas 18 along the Y direction is determined. If the dimensions of a single die 17 according to FIG. 5a are known, the actual achieved pixel resolution may also be calculated in number of pixels per length unit.

Subsequently, it is checked in step S12 whether the actually achieved pixel resolution Res_Pixel (IST) assumes a predefined value or not. According to FIG. 6, this value is identified as Res_Pixel (SOLL) and corresponds to a minimum resolution to be achieved plus/minus a predefinable tolerance.

If it is ascertained in step S12 that the actual achieved pixel resolution Res_Pixel (IST) in the X direction and the Y direction has not reached a predefined value Res_Pixel (SOLL), the size of the image field 8 is changed in step S13, i.e., enlarged or reduced, and the sequence returns to step S10 of a renewed sample image recording. The loop of steps S10 through S13 is executed until the condition in step S12 is fulfilled, for example, a desired minimum resolution is achieved. Subsequently, in step S14, an image is acquired of the surface 32 of the wafer 6, the acquired image is read out by the data readout unit, subsequently processed further with the aid of suitable image processing software known to one skilled in the art, and finally examined for defects and the like.

FIGS. 7 and 8 show alternative procedures, which may be executed in the scope of S11 for determining the actual achieved pixel resolution.

Of course, a minimum distance of the prominent structures, for example, the partition areas 18, to the edge of the actual acquired image field 8 may be checked and optimized in the loop of steps S10 through S12.

According to FIG. 7, the wafer inspection device may be operated in a learning mode. After the sample image recording was recorded in step S10, the die lattice is taught through a jump to program step A. For this purpose, the corners of individual dies (see FIG. 5a) may be input, using a numeric keyboard, or may be input interactively in software, for example, by marking the die corners using a mouse. The prominent structures thus taught are assigned to concrete pixels in the actual acquired image in step S21 and the actual achieved pixel resolution in the X direction and the Y direction is determined therefrom in following step S11. The procedure according to FIG. 7 is particularly suitable for manual or semiautomatic image field optimization.

FIG. 8 shows an alternative procedure, which is executed in connection with step S11 for image field optimization. Firstly, after the sample image recording of step S10 and a jump to program step A, prominent structures in the sample image recording are identified in the image field 8 in step S25. For this purpose, pattern recognition software, known from the related art, searches the sample image recording. Subsequently, the wafer 6 is moved in the X direction and/or in the Y direction by a predefined distance (step S26) with the aid of a X/Y movable table, a stepping motor, or the like of the wafer receiving unit 7. Subsequently, a second sample image recording is recorded and the same structures are sought in step S27 as in step S25, in order to identify their position, which has now changed, in the image field 8. An actual pixel size expressed in length per pixel may be ascertained from the number of pixels, which corresponds to the distance traveled in the X direction and/or the Y direction according to step S26.

The achievable pixel resolution in the acquired image field 8 may be concluded from the pixel size thus ascertained. The size of the image field 8 may be changed in accordance with FIG. 6 in this way until a desired pixel resolution is achieved.

As is obvious to one skilled in the art without anything further, the method described above may be performed manually, semiautomatically, or automatically in order to tailor the image field optimally to the particular conditions of a current wafer processing. In particular, the actual image field may be placed so that an individual die or subareas thereof lie in the actual image field optimally, i.e., with the least possible unused image area, a resolution in the X direction and/or the Y direction is optimal, in the event of a suddenly changed chip size, for example, in the manufacturing of ASICS, the image field is adapted rapidly, by changing the resolution of the wafer inspection device, different speeds and/or throughputs may be used, or even the entire surface of the wafer may be examined on the basis of a single image recording. Of course, the method according to the present invention may be executed with aid of a computer program, which is stored on a computer-readable or machine-readable data carrier, for example.

As is obvious to one skilled in the art without anything further, numerous modifications and variations may be performed without leaving the general idea of the achievement of the object and the scope of protection established by the following patent claims. Such modifications and variations are therefore also to be expressly included by the present invention.

### LIST OF REFERENCE NUMBERS

1 wafer inspection device
2 direct light illumination unit
3 objective
4 camera
5 objective
6 wafer
7 wafer receiving unit
8 image field of the camera 4
9 illumination axis
10 imaging axis
11 light source
12 optical fiber bundle
13 data line
14 data readout unit
15 monitor
16 stepper shot
17 die
18 partition area
19 connection line
20 connection line
21 image field without image field change
32 surface of the wafer 6
35 illuminated area
37 illumination light beam
x1, x2, y1, y2: distances
Nx, Ny: number of pixels in x/y direction

1. A method for the inspection of a wafer comprising the steps of:
(i) illuminating at least one section of a surface of the wafer;
(ii) acquiring an image of the illuminated section of the surface of the wafer by means of an image acquisition unit;
(iii) determining at least one image area in the acquired image; and
(iv) changing a size of an image field of the image acquisition unit on the basis of the at least one image area.

2. The method defined in claim 1, wherein changing the size of the image field is achieved by an adjustment of the focal width of an objective.

3. The method defined in claim 2, wherein the adjustment of the focal width of the objective is achieved by pivoting in another objective.

4. The method defined in claim 2, wherein the focal width is changed by adjusting a zoom objective.

5. The method defined in claim 1, wherein changing the size of the image field is executed so that a variable derived from at least one determined image area assumes a predetermined value or the derived variable is optimized.

6. The method defined in claim 5, wherein the predetermined value comprises one or more variables selected from the group consisting of a distance (x1, x2, y1, y2) of the at least one determined image area to edges of the acquired image field, a pixel resolution (Res_Pixel) of the image acquisition unit, a number of dies per acquired image field, a number of dies in the longitudinal and/or transverse direction of the acquired image field, and a throughput of a wafer inspection device per time unit.

7. The method defined in claim 5, wherein changing the size of the image field is executed iteratively until the variable derived from the at least one determined image area assumes a predetermined value or is optimized.

8. The method defined in claim 1, wherein the at least one determined image area comprises one or more dies or corresponds thereto.

9. The method defined in claim 1, wherein the determination of the at least one image area comprises the step of:
executing a pattern recognition (S2) to determine edges and/or corner areas and/or predetermined structures and/or marks on the surface of the wafer.

10. The method defined in claim 1, wherein the determination of the at least one image area also comprises the step of:
inputting edges and/or corner areas and/or predetermined structures and/or marks on the surface of the wafer.

11. The method as defined in claim 1 comprising the step wherein a pixel resolution of the image acquired by the image acquisition unit is determined automatically.

12. A device for the inspection of a wafer comprising: means for direct light illumination unit to illuminate a surface of a wafer; and means for image acquisition comprising at least one objective for acquiring an image of the surface of the wafer; said at least one objective having an adjustable focal width, so that a size of an image field of means for image acquisition is changeable.

13. The device as defined in claim 12, which comprises multiple objectives having different focal widths, the appropriate objective being adapted for pivotal movement.

14. The device as defined in claim 13, wherein said objective is a zoom objective.

15. The device as defined in claim 12, which comprises means for data readout adapted to read out image data of the image acquired by said means for image acquisition and to determine at least one image area in the acquired image; and a control means for changing the size of an image field of said means for image acquisition on the basis of the at least one image area determined by said means for data readout.

16. The device as defined in claim 15, wherein the control means for changing the size of an image field such that a variable derived from the at least one determined image area assumes a predetermined value or the derived variable is optimized.

17. The device as defined in claim 16, wherein the control means for changing the size of an image field is adapted so that the predetermined value comprises one or more variables selected from the group consisting of a distance (x1, x2, y1, y2) of the at least one determined image area to edges of the acquired image field, a pixel resolution (Res_Pixel) of the image acquisition unit, a number of dies per acquired image field, a number of dies in the longitudinal and/or transverse direction of the acquired image field, and a throughput of a wafer inspection device per time unit.

18. The device as defined in claim 17, wherein said control means for changing the size of an image field is adapted to change the size of the acquired image field iteratively until the variable derived from the at least one determined image area assumes a predetermined value or is optimized.

19. The device as defined in claim 18, wherein said means for data readout is adapted so that the at least one determined image area comprises one or more dies or corresponds thereto.

20. The device as defined in claim 19, wherein said means for data readout is adapted to execute pattern recognition to determine edges and/or corner areas and/or predetermined structures and/or marks on the surface of the wafer.

21. The device as defined in claim 20, wherein said edges and/or corner areas and/or predetermined structures and/or marks on the surface of the wafer may be input to said means for data readout.

22. The device as defined in claim 21, wherein said means for data readout is adapted to determine a pixel resolution of the image acquired by said means for image acquisition automatically.
